(19) United States
(12) Patent Application Publication
(10) Pub. No.: US 2021/0307288 A1
(43) Pub. Date: Oct. 7, 2021

(54) PORTABLE PET WEIGHTED BASE

(71) Applicant: Duane Reynolds, Avon, IN (US)

(72) Inventor: Duane Reynolds, Avon, IN (US)

(21) Appl. No.: 17/206,686

(22) Filed: Mar. 19, 2021

Related U.S. Application Data
(60) Provisional application No. 63/002,745, filed on Mar. 31, 2020.

(51) Int. Cl. A01K 3/00; A01K 27/00

(52) U.S. Cl. CPC A01K 3/00; A01K 27/003

(57) ABSTRACT

A stationary base assembly for restricting the movement of a pet, including a first generally circular top surface, a first rubberized generally circular bottom surface, and a first generally cylindrical endless wall extending between the first generally circular top surface and the first generally circular bottom surface and defining a first cylindrical body having a first inner volume. A first is aperture formed through the first generally circular top surface for fluidic communication with the first inner volume. A first plurality of spaced lugs extend from the first generally circular top surface and a first plurality of spaced recesses are formed in the first generally circular bottom surface, wherein the first plurality of spaced recesses are sized, shaped, and positioned to engage the first plurality of spaced lugs. A leash engaging assembly is operationally connected to the first cylindrical body. A stacking unit is operationally connected to the first generally circular top surface. The stacking unit further includes a second generally circular top surface, a second generally circular bottom surface, and a second generally cylindrical endless wall extending between the second top surface and the second bottom surface to define a second cylindrical body having a second inner volume. A second aperture is formed through the second top surface for fluidic communication with the second inner volume. A second plurality of spaced lugs extends from the second top surface and a second plurality of spaced recesses is formed in the second bottom surface and lockingly engaged to the first plurality of spaced lugs. A bifurcated dish member is operationally connected to the second top surface, wherein the bifurcated dish member further includes a generally circular recessed body portion, a divider wall bifurcating the generally circular recessed body portion, and a plurality of recesses formed in the generally circular body portion lockingly engaged to the second plurality of spaced lugs.

### CROSS-REFERENCE TO RELATED APPLICATIONS

This patent application claims priority to U.S. provisional patent application Ser. No. 63/002,745, filed on Mar. 31, 2020.

### TECHNICAL FIELD

The present novel technology relates generally to the animal care, and, more particularly, to a portable weighted base for leashing an animal.

### BACKGROUND

Pet owners typically restrict the movement of their animals by keeping the pet in a crate or cage, or by gating off certain areas of the house. While these methods are effective, keeping a pet in a crate seriously restricts it movement and ability to exercise, while gating off certain areas of the house requires costly and bulky gating that is likewise inconvenient and often unsightly for the occupants. Thus, there is a means for restricting pet movement that still allows the pet to get some exercise that does not restrict the movement of the human occupants as well. The present novel technology addresses this need.

### BRIEF DESCRIPTION OF THE DRAWINGS

FIG. 1 is a side elevation view of a first embodiment weighted pet station of the present novel technology.

FIG. 2 is a top plan view of the pet station of FIG. 1.

FIG. 3 is a bottom plan view of the pet station of FIG. 1.

FIG. 4 is a perspective view of the pet station of FIG. 1.

FIG. 5A is a top plan view of a dish attachment connected to the pet station of FIG. 1.

FIG. 5B is a side elevation view of the dish attachment of FIG. 5A.

FIG. 5C is a bottom plan view of the dish attachment of FIG. 5B.

FIG. 6A is a side elevation view of a stacking module.

FIG. 6B is a bottom plan view of the stacking module of FIG. 6B.

FIG. 7 is a side elevation view of the pet station of FIG. 1 including a side mounted leash connection ring.

FIG. 8 is a partial exploded view of the connection ring of FIG. 7.

FIG. 9 is a partial exploded cutaway view of the interconnection of the top lugs of the pet station of FIG. 1 with the bottom recesses of the stacking module of FIG. 6A.

FIG. 10 is a partial enlarged perspective view of a leash as used with the above embodiments.

### DETAILED DESCRIPTION OF THE PREFERRED EMBODIMENT

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

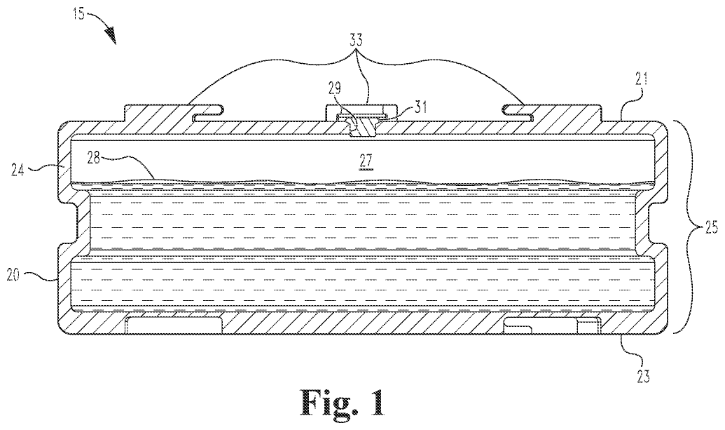

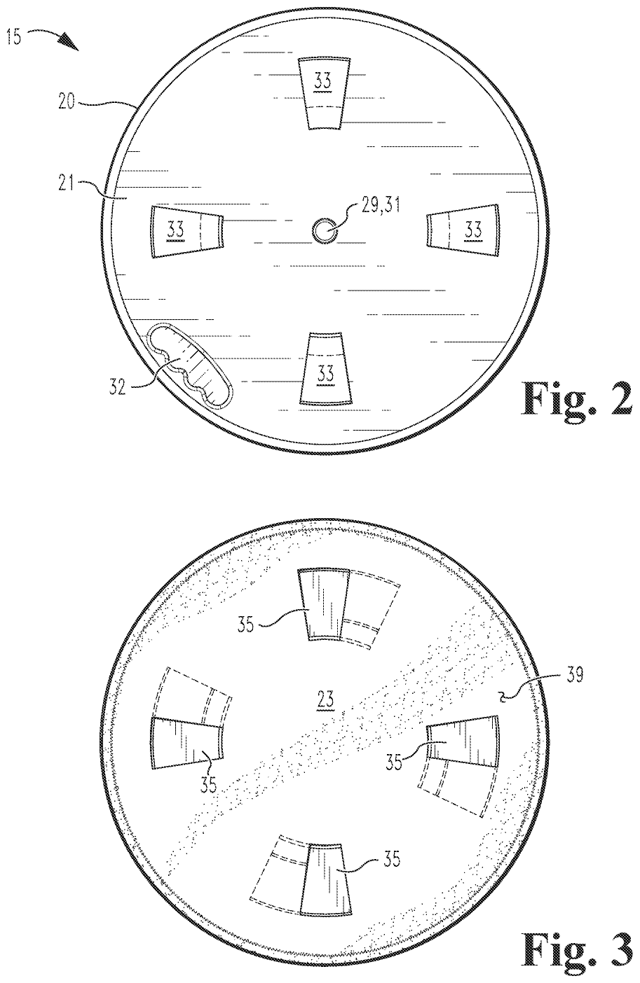

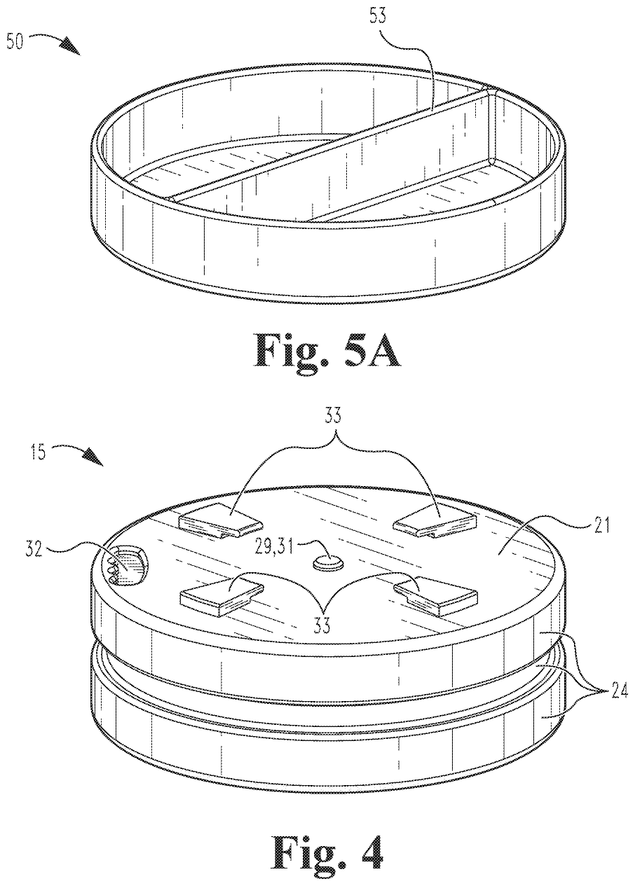

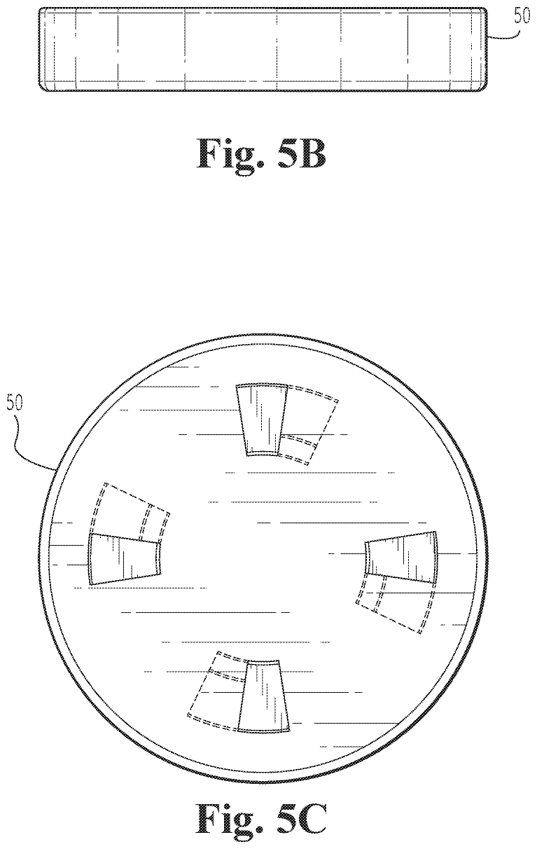

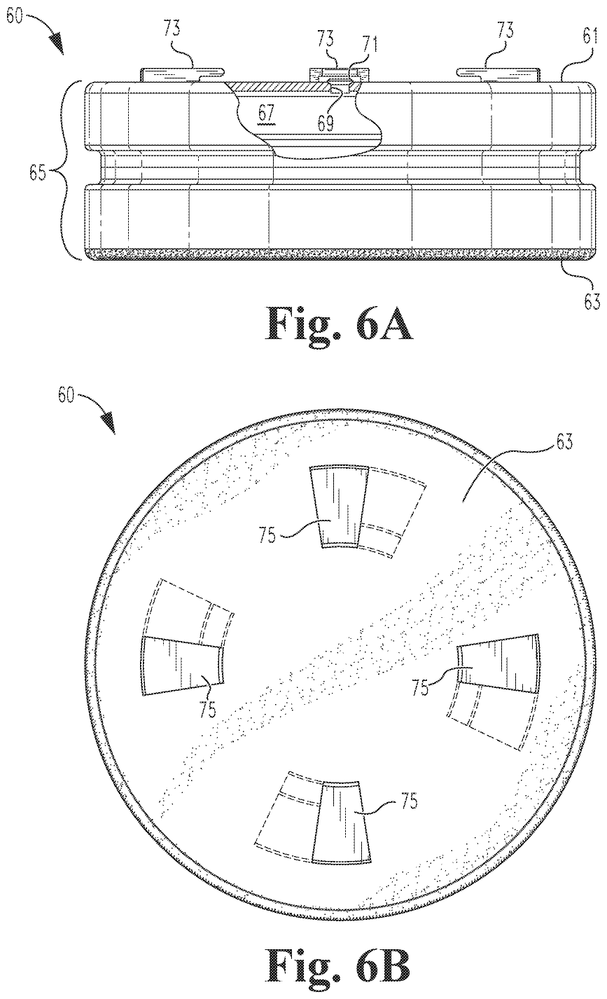

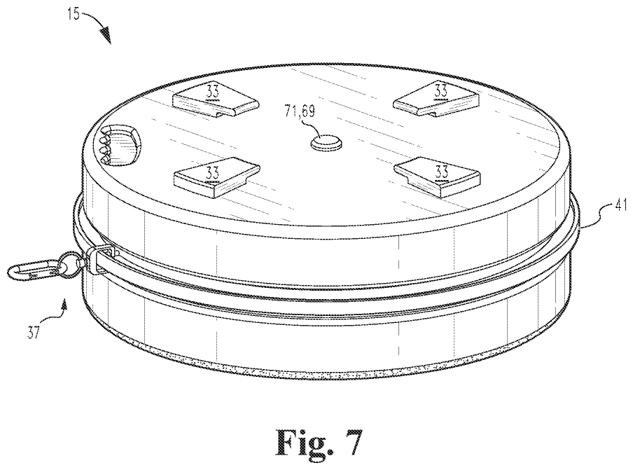

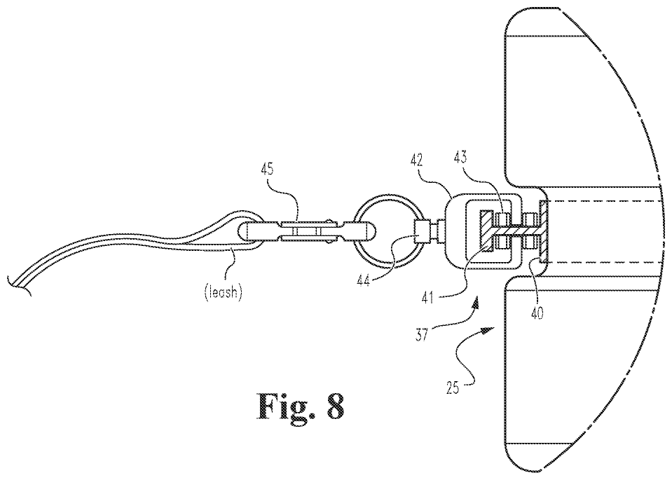

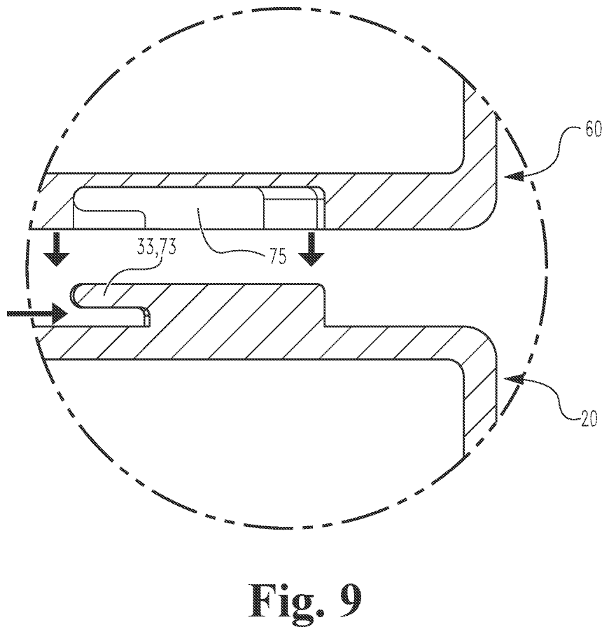

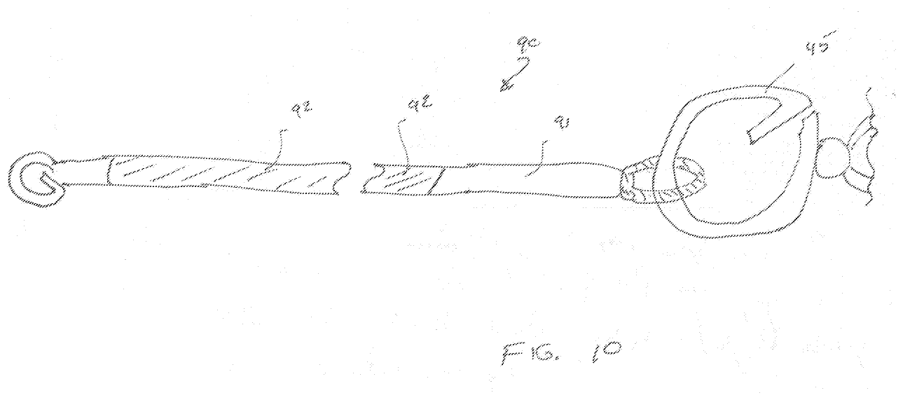

Referring to FIGS. 1-10, the novel technology relates to a portable weighted base station assembly 15 to which a leash may be connected. The base station assembly 15 includes a base station 20 that typically has generally circular top and bottom surfaces 21, 23 with an endless wall 24 extending therebetween to define a short, flattened, generally cylindrical body 25. The cylindrical body 25 defines a hollow interior volume 27 that may be filled with water 28. Alternately, the interior volume 27 may be filled with sand or the like. The cylinder 25 is typically about four inches high and has a diameter of about twelve inches and can be filled with about two gallons of water (sixteen pounds). The bottom surface 23 of the cylinder 25 is configured to be matingly stacked with the top surface 21 of the cylinder 25, such that two or more base stations 20 may be filled, stacked, and locked together to increase the weight of the base 20 for leashing larger and stronger animals.

Typically, the top surface 21 includes a plurality of spaced lug members 33 extending therefrom, while the bottom surface 23 includes a plurality of spaced recesses 35 positioned to receive the respective lug members 33. The lug members 33 may engage the recesses 35 in an interference fit or may be configured to rotatedly lock into the recesses 35. Typically, the base 20 includes a rubberized or otherwise skid-proof bottom layer 39 and/or feet operationally connected to the bottom surface 23.

A leach engaging assembly 37 is typically operationally connected to the cylindrical body 25. The leash engaging assembly 37 may be a handle 37 extending from the top surface 21. A leash of any desired length may be affixed to the base 20, such as to the leash handle 37, and the base 20 positioned to allow the leashed pet limited roaming space. The base station 20 may be positioned such that the leashed pet may have plenty of roaming space, but still restricts pet access to certain furniture, fixtures, appliances or the like.

In some embodiments, the leash engaging assembly 37 includes an aluminum or like structural band 40 encircles the cylindrical portion 25 and defines a T-ring 41 extending therefrom. A roller bracket 42 is connected to the T-ring 41 by gripping engagement of the rollers 43, and a (typically metal) swivel 44 extends from the roller bracket 42 and is connected to a connector 45 (typically a snap-ring 45) for attaching a leash. The roller bracket 42 is free to move around the cylindrical body 25. Additional roller brackets 42 with connected swivels 44 and connectors 45 may be rollingly attached to the T-ring 41 so that more than one animal may be leashed to the base 20 at any given time. In other embodiments, an extendable leash line is connected to the base unit 20 for connecting directly to a dog's collar. In other embodiments, one or more extendable leash lines is connected to the base unit 20 for connecting directly to a dog's collar.

Typically, a divided dish 50 is provided for attachment to the top surface 21. The dish is typically circular and includes bottom recesses 51 sized, shaped, and positioned to receive top lugs 33 so that the dish may be secured to the base unit 20. The dish is typically bifurcated by a dividing wall 53, so that it may simultaneously hold food and water.

One or more stacking modules 60 may likewise be filled with water and stacked on the base 20 to add weight thereto. Stacking modules 60 are very similar to the base unit 20, and include a cylindrical body 65 extending between top and bottom surfaces 61, 63, wherein the top surface 61 includes top lugs 73 extending therefrom and the bottom surface includes recesses 75 sized, shaped, and positioned to receive top lugs 33, 73. The cylindrical body 65 defines a hollow volume 67 that may be filled with water through a fill aperture 69 to provide appropriate weight, with a fill cap 71 provided to plug the fill aperture 69 when not in use.

Typically, the cylindrical bodies 25, 65 are about thirty (30) cm in diameter and about twelve (12) cm in height. The ratio of height to diameter is maintained at about 1:3 in order to maintain the stability of the system 15 in response to the tug or pull of one or more leashed animals.

In some embodiments an elongated flexible leash member 90 is provided for attachment to the pet base 20, typically via connector 45. The leash member 90 includes a substantially inelastic portion 91 connected to a substantially elastic portion 92. The elastic portion 92 responds to a sudden urging force as applied by a leashed animal to mitigate any opposing counter force experienced by the animal (in other words, the elastic portion 90 acts as a shock absorber to protect both the animal and the base from sudden jerks on the part of the animal). This is intended to both protect the animal from injury, protect the base from being dislodged, and discourage the animal from attempting to escape from the base.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

I claim:

1. A stationary base assembly for restricting the movement of a pet, comprising:
a generally circular top surface;
a generally circular bottom surface, wherein the bottom surface is rubberized;
a generally cylindrical endless wall extending between the top surface and the bottom surface to define a cylindrical body having an inner volume;
an aperture formed through the top surface for fluidic communication with the inner volume;
a plurality of spaced lugs extending from the top surface;
a plurality of spaced recesses formed in the bottom surface, wherein the plurality of spaced recesses are sized, shaped, and positioned to engage the plurality of spaced lugs; and
a leash engaging assembly operationally connected to the cylindrical body.

2. The stationary base assembly of claim 1 and further comprising:
a stacking unit operationally connected to the generally circular top surface, the stacking unit further comprising:
a generally circular stacking unit top surface;
a generally circular stacking unit bottom surface;
a generally cylindrical stacking unit endless wall extending between the stacking unit top surface and the stacking unit bottom surface to define a stacking unit cylindrical body having a stacking unit inner volume;
a stacking unit aperture formed through the stacking unit top surface for fluidic communication with the stacking unit inner volume;
a plurality of spaced stacking unit lugs extending from the stacking unit top surface;
a plurality of spaced stacking unit recesses formed in the stacking unit bottom surface and lockingly engaged to the plurality of spaced lugs.

3. The stationary base assembly of claim 2 wherein both the inner volume and the stacking unit inner volume are substantially filled with water.

4. The stationary base assembly of claim 1 wherein the leash engaging assembly is a handle operationally connected to the stationary base assembly.

5. The stationary base assembly of claim 1 wherein the leash assembly further comprises:
an aluminum band encircling the cylindrical body and defining a T-ring;
at least one roller bracket operationally connected to the T-ring;
at least one swivel member operationally connected to the at least one roller bracket; and
at least one connector operationally connected to the at least one swivel member for lockingly accepting a leash.

6. The stationary base assembly of claim 1 and further comprising:
a bifurcated dish member operationally connected to the top surface, wherein the bifurcated dish member further comprises a generally circular recessed body portion; a divider wall bifurcating the generally circular recessed body portion; and a plurality of recesses formed in the generally circular body portion lockingly engaged to the plurality of spaced lugs.

7. The stationary base assembly of claim 2 and further comprising:
a bifurcated dish member operationally connected to the stacking member top surface, wherein the bifurcated dish member further comprises a generally circular recessed body portion; a divider wall bifurcating the generally circular recessed body portion; and a plurality of recesses formed in the generally circular body portion lockingly engaged to the plurality of spaced stacking member lugs.

8. The stationary base assembly of claim 5 and further comprising:
an elongated flexible member operationally connected to the at least one connector, wherein the elongated flexible member includes an inelastic portion and an elastic portion connected thereto.

9. A stationary base assembly for restricting the movement of a pet, comprising:
a first generally circular top surface;
a first rubberized generally circular bottom surface;
a first generally cylindrical endless wall extending between the first generally circular top surface and the first generally circular bottom surface and defining a first cylindrical body having a first inner volume;
a first aperture formed through the first generally circular top surface for fluidic communication with the first inner volume;
a first plurality of spaced lugs extending from the first generally circular top surface;
a first plurality of spaced recesses formed in the first generally circular bottom surface, wherein the first plurality of spaced recesses are sized, shaped, and positioned to engage the first plurality of spaced lugs; and
a leash engaging assembly operationally connected to the first cylindrical body;
a stacking unit operationally connected to the first generally circular top surface, the stacking unit further comprising:
a second generally circular top surface;
a second generally circular bottom surface;
a second generally cylindrical endless wall extending between the second top surface and the second bottom surface to define a second cylindrical body having a second inner volume;
a second aperture formed through the second top surface for fluidic communication with the second inner volume;
a second plurality of spaced lugs extending from the second top surface;
a second plurality of spaced recesses formed in the second bottom surface and lockingly engaged to the first plurality of spaced lugs;
a bifurcated dish member operationally connected to the second top surface, wherein the bifurcated dish member further comprises a generally circular recessed body portion; a divider wall bifurcating the generally circular recessed body portion;
and a plurality of recesses formed in the generally circular body portion lockingly engaged to the second plurality of spaced lugs.

10. The stationary base assembly of claim 8 wherein the leash assembly further comprises:
an aluminum band encircling the first cylindrical body and defining a T-ring;
at least one roller bracket operationally connected to the T-ring;
at least one swivel member operationally connected to the at least one roller bracket; and
at least one connector operationally connected to the at least one swivel member for lockingly accepting a leash.

11. The stationary base assembly of claim 10 and further comprising:
an elongated flexible member operationally connected to the at least one connector, wherein the elongated flexible member includes an inelastic portion and an elastic portion connected thereto.
